(19) United States
(12) Patent Application Publication
(10) Pub. No.: US 2014/0349710 A1
(43) Pub. Date: Nov. 27, 2014

(54) PLUG MODULE FOR A MOBILE TELEPHONE HOLDER

(71) Applicant: Harald Richter, Engelsbrand (DE)

(72) Inventor: Harald Richter, Engelsbrand (DE)

(21) Appl. No.: 14/283,111

(22) Filed: May 20, 2014

(30) Foreign Application Priority Data
May 21, 2013 (DE) 20 2013 004 632.5

(51) Int. Cl. H04M 1/04; H04B 1/38

(52) U.S. Cl. CPC H04M 1/04; H04B 1/3883
USPC 455/557

(57) ABSTRACT

In a universal plug module for use in connection with a universal mobile telephone holder comprising a frame for connection to the telephone holder and a plug carrier block, a plug holder insert is provided for installation in the plug carrier block, which plug holder insert has an opening for accommodating for example a charger plug which can be fixed in position together with the plug disposed in the plug carrier block insert by means of a clamping element.

The invention resides in a plug module for a mobile telephone holder, in particular a universal plug-in module for use, or in connection with, a universal mobile telephone holder.

The design of mobile telephone holders with integrated charger plugs for charging a mobile telephone while it is located in the holder is known per se. Because the arrangement and the form of the charger plugs of the mobile telephones presently commercially available and the charger plugs needed therefor are different, mobile telephone holders with integrated charger plugs are used only rarely and only in connection with holders which are specifically adapted to the respective mobile telephone.

In connection with universal telephone holders which are mostly in the form of clamping pad holders, the mobile telephone is generally charged via a cable which is plugged into the phone and into an electric receptacle in a motor vehicle. This requires of course the plugging-in of the charging cable into the mobile telephone or, respectively, the unplugging of the charging cable when the mobile phone is removed therefrom.

It is the object of the present invention to provide a universal plug-in module which can be used together with a universal mobile telephone holder and which permits the plugging in and the unplugging of the mobile telephone into, or its unplugging from, a charging plug (or a data cable plug) upon insertion of the mobile telephone into, or its removal from, the holder.

### SUMMARY OF THE INVENTION

In a universal plug module for use in connection with a universal mobile telephone holder comprising a frame for connection to the telephone holder and a plug carrier block, a plug holder insert is provided for installation in the plug carrier block, which plug holder insert has an opening for accommodating for example a charger plug which can be fixed in position together with the plug disposed in the plug carrier block insert by means of a clamping element.

The plug module according to the invention is releasably connected to the mobile telephone holder. It may also be firmly connected to the telephone holder for example by means of screws. It may further be integrated into the telephone holder.

A releasable connection may be established for example by locking pins which extend into corresponding engagement openings of the telephone holder.

A preferred embodiment of the invention is based for example on mobile telephone holders as they are described in Applicants EP 1 582 409 D1 and which have, in the use position, on a lower edge area of the telephone holder, a guide groove, in which end parts of support fingers are slidably accommodated and on which the bottom edge area of the mobile telephone is supported. The plug-in module is in this case provided with a corresponding shape-locking profile which is insertable into such a guide groove instead of the support fingers. In this way, the plug module according to the invention can replace the guide or support fingers which then are no longer necessary because the plug module assumes that task. The plug module according to the invention can be installed in all universal telephone holders which are commercially available.

The plug module according to the invention consists of a frame which, in an embodiment in which it is connectable to a telephone holder, is provided with coupling means and a carrier block which preferably is adjustable on the frame by a certain adjustment length in forward and backward direction as well as a plug holder insert which is inserted replaceably into the plug carrier block. The plug holder insert is removably inserted into a vertical opening of the carrier block. This plug holder insert is formed for accommodating a certain charger plug or another plug of a particular mobile telephone or particular telephones. It may be for example a micro-USB plug or another plug. This holder insert is a simple inexpensive plastic part so that various such holder inserts may be supplied with the plug module according to the invention to allow for accommodation of practically all common micro-USB plugs so that a user can choose the insert plug needed for the accommodation of his charger plug.

The holder insert accommodates for example the charger plug of a charger cable. The charger plug can safely be fixed together with the holder insert in the carrier block by means of a clamping screw with a manually operable rotatable knob or a lever which is provided at the back of the carrier block. Alternatively, a permanent spring-loaded clamping arrangement may be provided. However, a clamping screw is preferred since it permits an adjustment of the clamping force and a release of the clamping force so that the holder insert with the plug can be removed and inserted without wear or damage. In this way also, the possible weakening of a spring force is omitted.

Below, an exemplary embodiment of the invention will be described with reference to the accompanying drawings.

### BRIEF DESCRIPTION OF THE DRAWINGS

FIG. 1 is a perspective front side view of the plug module

according to the invention,

FIG. 2 is a perspective rear side view of the plug module,

FIG. 3 shows the plug module from the front,

FIG. 4 is a sectional view taken along line A-A of FIG. 3,

FIG. 5 is a sectional view taken along line B-B of FIG. 3,

FIG. 6 is a top view of the plug module according to the invention,

FIG. 7 is perspective view of a mobile telephone holder with a plug-module installed shown in a perspective front view, and

FIG. 8 is a perspective view of a mobile telephone holder with a plug-module installed shown in a perspective rear view.

### DESCRIPTION OF AN EXEMPLARY EMBODIMENT

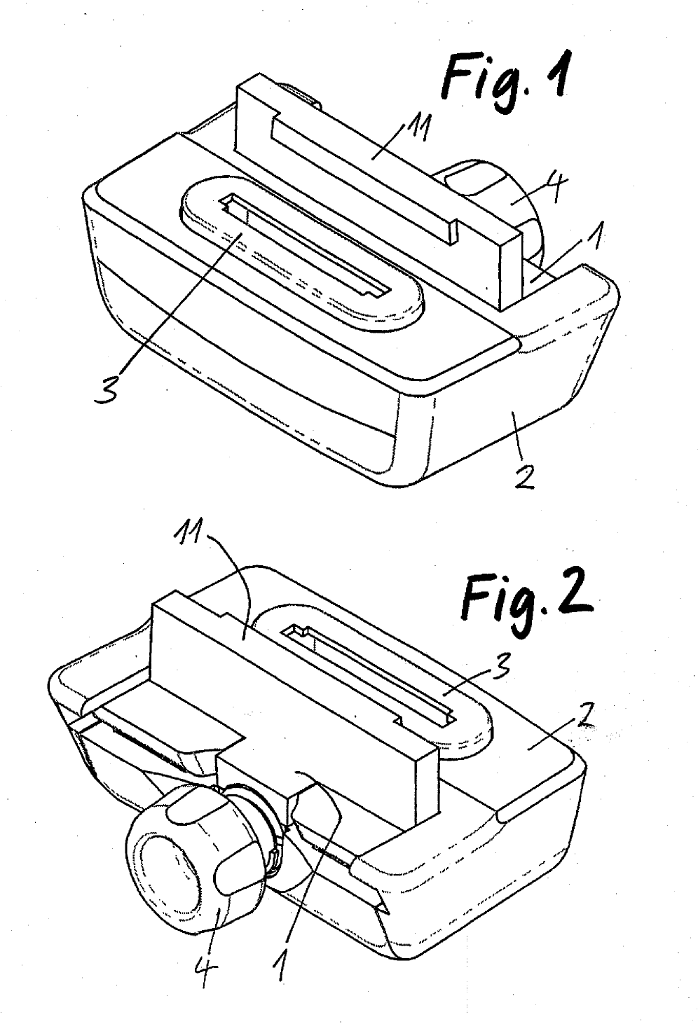

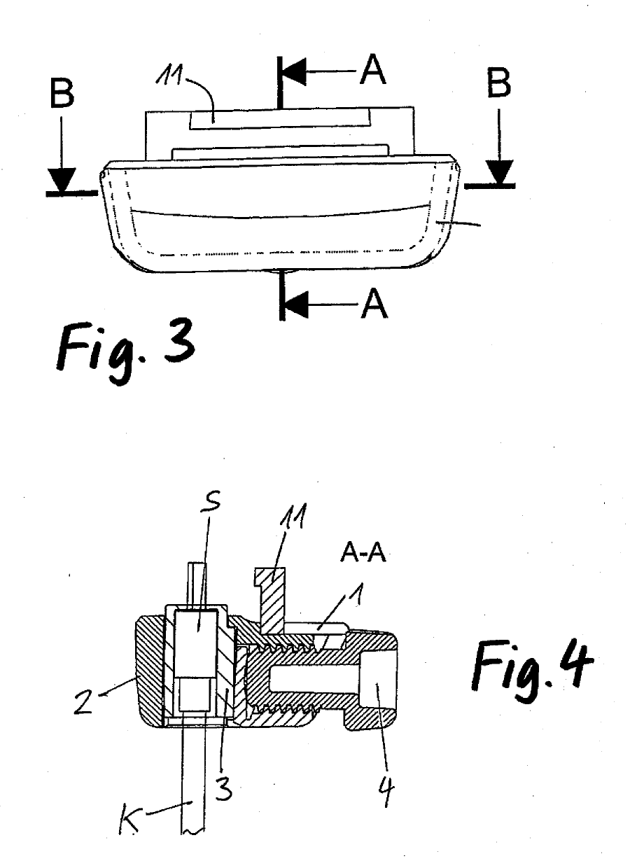

FIGS. 1 and 2 show the plug module according to the invention in a perspective view at an angle from the front and, respectively, at an angle from the rear. It comprises a frame 1 which is provided with a coupling element 11. The coupling element 11 is L-shaped and arranged upside-down so that it can be inserted into a guide groove provided on a known universal telephone holder at the lower and possibly the upper edge area of the mobile telephone holder. The coupling element 11 is normally provided for accommodating end sections of support legs which are sidewardly adjustably arranged for supporting the bottom edge section of a mobile telephone placed into the mobile telephone holder.

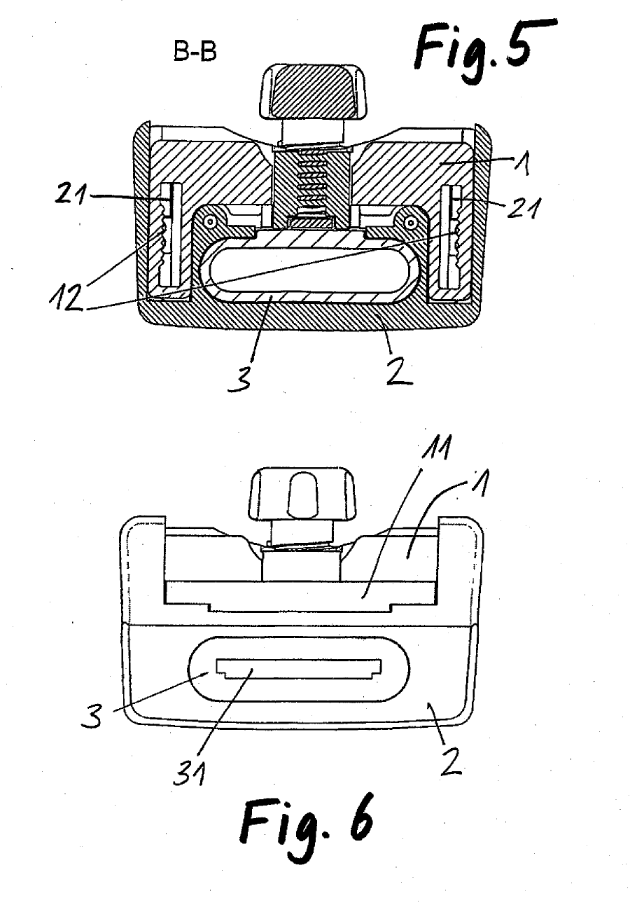

As further apparent from FIGS. 4 and 5, which show sections along the lines A-A and, respectively, B-B as marked in FIG., a plug carrier block 2 is supported on the frame 1 so as to be slideable in forward and backward direction and this plug carrier block 2 forms at the same time the housing which is visible from without.

FIG. 5 shows an engagement mechanism 12 which includes engagement tooth strips formed on the frame 1 and leaf springs 21 connected to the plug carrier block 2 and also counter elements which cooperate with the engagement tooth strips. In this way, the plug carrier block 2 is slidable on the frame 1 in forward and backward directions in small engagement steps.

In the plug carrier block, a plug holder insert 3 is accommodated. In the exemplary embodiment, the plug holder insert 3 is disposed from the bottom as shown in FIG. 4. However, it may also be inserted from the top. This is not significant as far as the invention is concerned.

The plug insert 3 has an opening 31 for accommodating for example a charger plug. This accommodation opening 31 is adapted specifically to a certain charger plug for a certain mobile telephone or a certain group of mobile telephones of a particular manufacturer so as to be capable to accommodate the particular charger plug properly.

Since the plug holder insert 3 is only a small inexpensive plastic part, it can be manufactured at little cost in several versions with different accommodation openings 31 corresponding to the shapes of the most common charger plugs or micro USB plugs and an assortment of such plug holder inserts 3 may be supplied with each plug module, so that the user has for each common plug the proper insert readily available for installation in the opening 31.

Since the charger plug on the charger cable needs of course to be fixed in the plug module in such a way that it can be installed into the plug holder insert 3 and also be again released therefrom without excessive force and without being damaged, a clamping screw 4 is provided which is screwed into the plug carrier block 2 and which presses against the rear wall of the plug holder insert 3. The holder insert has a certain elasticity as it consists of a plastic material which, upon tightening of the clamping screw 4 elastically compresses the plug holder insert 3 and firmly engages also the charger plug disposed in the plug holder.

In the sectional view A-A of FIG. 4, a charger plug S of a charger cable K inserted into the charger holder insert 3 is shown. If can be seen therefrom that the clamping screw 4 does not directly engage the holder insert 3 but via a flag arranged in the carrier block.

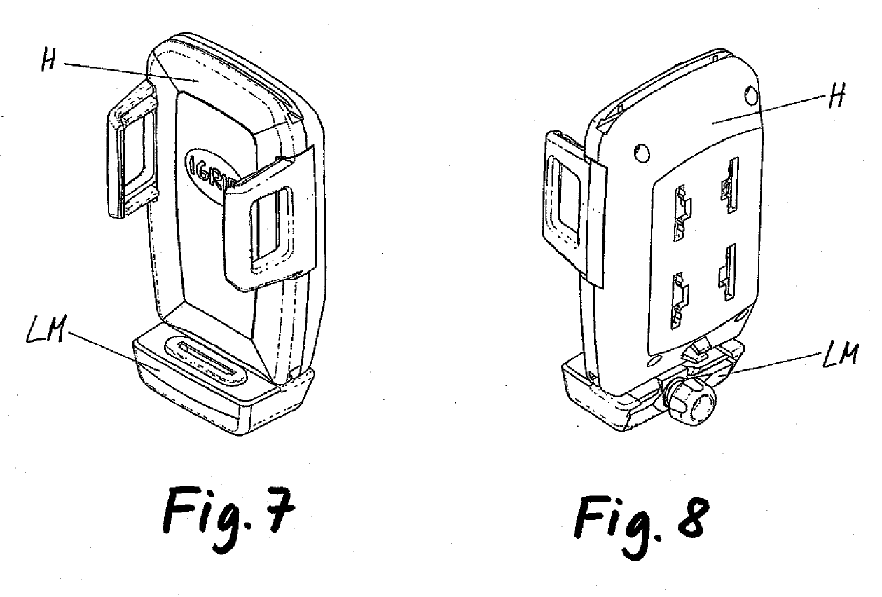

FIGS. 7 and 8 each show a universal telephone holder H in a perspective view at an angle from the front or the back, with the plug module LM mounted to the universal mobile telephone holder H.

In the shown exemplary embodiment, the plug carrier block is slidable in forward-backward direction guided by the frame in order to accommodate charger receptacles having different positions in the bottom edge area of the mobile telephones in the forward-backward direction.

The design can be simplified in particular by omitting the forward-backward adjustability of the carrier block 2 in the frame 1 and providing a rigid arrangement thereof on the frame. This is possible if the plug holder insert 3 is modified in such a way that it adapts also to possible variations in the positioning for example of the charger receptacle on the mobile telephone in the forward and backward direction. This is reasonable in particular with regard to the fact that several plug holder inserts are to be provided for the plug module, which plug holder inserts are adapted to one of the common charger plugs and from which the user can select the one that fits his application. To this end, all plug holder inserts have a particular depth in forward-backward direction which covers the whole possible range of the desired charger receptacle depth in the forward-backward direction is then provided in accordance with the respective model. Then a user only has to pay attention that the plug holder insert is not installed reversed into the frame by reversal of the front or backside which however can be ensured by common mechanical coding means which prevent an incorrect installation.

All that has been described above in connection with the exemplary embodiment with regard to a charger plug applies equally to plugs of data transmission cables.

What is claimed is:

1. A universal plug module for use in connection with, a universal mobile telephone holder, comprising:
a frame (1) for connection to the telephone holder,
a plug carrier block (2) and a plug holder insert (3) for removable installation in the plug carrier block (2),
the plug holder insert (3) having an accommodation opening (31) for the insertion of a charger plug or a data cable plug, and
a clamping element (4) for fixing the plug holder insert (3) together with the charger or data cable plug inserted into the charger plug engaged in the plug carrier block (2).

2. The universal plug module according to claim 1, wherein the frame (1) is provided with at least one coupling means (11) for connection to a lower edge area of the mobile telephone holder.

3. The universal plug module according to claim 2, wherein the coupling means (11) is a profile strip which is insertable into a guide groove provided in the lower edge area of the mobile telephone holder for accommodating support legs.

4. The universal plug module according to claim 1, wherein the clamping element (4) is a clamping screw which engages and fixes the plug holder insert (3) together with the plug (5) received therein in the plug carrier block (2).

5. The universal plug module according to claim 1, wherein the plug carrier block (2) is arranged so as to be adjustable by a certain adjustment distance in the forward-backward direction.

6. The universal plug module according to claim 5, wherein the plug carrier block (2) is adjustable in steps in the forward-backward direction by a ratchet mechanism (12) within a certain adjustment distance.

7. The universal plug module according to claim 1, wherein the plug carrier block (2) is fixedly arranged on the frame (1) and the plug carrier insert (3) has in the forward-backward direction a depth which is sufficient to arrange the accommodation opening (31) for inserting the plug in the forward-backward direction in the proper position corresponding to the respective plug and the associated mobile telephone model.

8. The universal plug module according to claim 1, wherein several plug holder inserts (3) with different accommodation openings (3) are provided which are adapted to accommodate different common plugs.
